(19) United States
(12) Patent Application Publication
(10) Pub. No.: US 2010/0075015 A1
(43) Pub. Date: Mar. 25, 2010

(54) Method for Preparing Alpha Acid-Enriched Hop Compositions

(75) Inventors: Mitsunori Ono, Lexington, MA (US); Naoto Yamaguchi, Bethesda, MD (US)

Correspondence Address: EDWARDS ANGELL PALMER & DODGE LLP, P.O. BOX 55874, BOSTON, MA, 02205, US

(73) Assignee: Betal, LLC, Washington, DC (US)

(21) Appl. No.: 12/468,570

(22) Filed: May 19, 2009

Related U.S. Application Data
(60) Provisional application No. 61/054,353, filed on May 19, 2008.

(51) Int. Cl. C12C 3/02; C12C 3/08

(52) U.S. Cl. 426/600; 426/495; 426/456

(57) ABSTRACT

This invention relates to a method of preparing an alpha acid-enriched hop composition that contains a low level of beta acids.

### CROSS-REFERENCE TO RELATED APPLICATION

This application claims the benefit of the following U.S. Provisional Application No.: 61/054,353, filed on May 19, 2008, the entire contents of which are incorporated herein by reference.

### BACKGROUND OF THE INVENTION

Hop products that contain alpha acids and beta acids, both of which exhibit various beneficial effects, are not suitable for making food products or food supplements due to the unpleasant strong cheesy odor released from the beta acids. Thus, there is a need to develop a new method for preparing hop compositions containing elevated levels of alpha acids and reduced levels of beta acids.

### SUMMARY OF THE INVENTION

The present invention generally provides a method for preparing an alpha acid-enriched hop composition. This method includes at least the following three steps: (1) dissolving in water a hop extract containing both alpha and beta acids to obtain a first aqueous solution, the content of the alpha acids in the hop extract being at least about 50-85% (e.g., 50%, 55%, 60%, 65%, 70%, 75%, 80%, 85%, or more) by weight; (2) adjusting the pH value of the first aqueous solution to at least about 7-9 (e.g., 7, 8, 8.4, 9) to precipitate the beta acids; and (3) removing the precipitated beta acids to obtain an alpha acid-enriched hop composition. The hop composition, when dried by, e.g., spray drying, contains at least about 70-95% (e.g., 70-80%, 75-85%, or 80-90%) by weight alpha acids and at least about 0.05-0.5% (e.g., 0.05-0.2% or 0.1-0.2%) by weight beta acids.

In one embodiment, after removing the precipitated beta acids as described in step (3) above, the resultant solution is mixed with a water-soluble sugar (e.g., monosaccharide, oligosaccharide, or polysaccharide) or a sugar alcohol (e.g., mannitol, sorbitol, or xylitol) to allow formation of precipitates, which are then removed to produce an alpha acid-enriched hop composition. This hop composition, in dry form, can contain at least about 25-50% (e.g., 25-30%, 30-35%, 35-40%, 40-45%, and 45-50%) by weight alpha acids and about 0.02-0.2% (e.g., 0.1-0.2% or 0.05-0.1%) by weight beta acids.

In another embodiment, after removing the precipitated beta acids as described in step (3) above, the resultant solution is mixed with a water insoluble polymeric adsorbent, which is then removed to produce an alpha-acid enriched hop composition. The hop composition thus obtained, in dry form, contains at least about 70-95% by weight alpha acids and about 0.05-0.5% by weight beta acids. Examples of polymeric adsorbents include, but are not limited to, Amberlite FPX 66, XAD7HP, Zeolite, polyvinylpolypyrrolidone (PVPP), and charcoal (preferably acid-treated charcoal).

In one aspect, the invention generally provides a method of preparing an alpha acid-enriched hop composition, involving dissolving in water a hop extract comprising alpha acids and beta acids to obtain a first aqueous solution, where the content of the alpha acids in the hop extract is about 50-85% (e.g., 50%, 55%, 60%, 65%, 70%, 75%, 80%, 85%) by weight, adjusting the pH value of the first aqueous solution to 7-9 (e.g., 7. 8, 8.4, 9) to precipitate the beta acids; and removing the precipitated beta acids to obtain an alpha acid-enriched hop composition, which, when in dry form, contains at least about 70-95% (e.g., 70%, 75%, 80%, 85%, 90%, 95%) by weight alpha acids and about 0.05-0.5% (e.g., 0.05%, 0.075%, 0.1%, 0.2%, 0.3%, 0.4%, 0.5%) by weight beta acids.

In another aspect, the invention provides a method of preparing an alpha acid enriched hop composition, involving dissolving in water a hop extract comprising alpha and beta acids to obtain a first aqueous solution, where the content of the alpha acids in the hop extract is 50-85% by weight; adjusting the pH value of the first aqueous solution to 7-9 to allow precipitation of the beta acids; removing the precipitated beta acids to form a second aqueous solution; mixing the second aqueous solution with a sugar and/or a sugar alcohol to allow formation of precipitates, removing the precipitates to form an alpha-acid enriched hop composition, which, when in dry form, contains at least about 25-50% by weight alpha acids and about 0.02-0.2% by weight beta acids. In one embodiment, the second aqueous solution is mixed with a monosaccharide, oligosaccharide, or polysaccharide (e.g., maltodextrin and/or starch). In another embodiment, the second aqueous solution is mixed with a sugar alcohol selected that is any one or more of mannitol, sorbitol, and xylitol. In yet another embodiment, the pH value of the first aqueous solution is adjusted to 8.4.

In yet another aspect, the invention provides a method of preparing an alpha acid enriched hop composition, involving dissolving in water a hop extract comprising alpha and beta acids to obtain a first aqueous solution, where the content of the alpha acids in the hop extract is 50-85% by weight, adjusting the pH value of the first aqueous solution to about 7-9 to allow precipitation of the beta acids, removing the precipitated beta acids to form a second aqueous solution, mixing the second aqueous solution with a water insoluble polymeric adsorbent; and removing the water insoluble polymeric adsorbent to form an alpha acid-enriched hop composition, which, when in dry form, contains at least about 70-95% by weight alpha acids and about 0.05-0.5% by weight beta acids. In one embodiment, the polymeric adsorbent is selected from the group consisting of Amberlite FPX 66, XAD7HP, Zeolite, polyvinylpolypyrrolidone (PVPP), and charcoal. In another embodiment, the pH value of the first aqueous solution is adjusted to 8.4.

In yet another aspect, the invention provides a method of preparing an alpha-acid enriched hop composition, involving preheating a hop composition comprising about 80% by weight alpha acids and about 3% beta acids to 60-65° C. with water to form a first solution; adjusting the pH of the solution to 8.0 to 8.4 and removing insoluble materials to obtain a first solution; contacting the first solution with a polymeric adsorbent and isolating from the adsorbent a second aqueous solution comprising about 16% alpha acids; contacting the second aqueous solution with a modified starch to produce an alpha acid containing mixture comprising about 30% by weight of the modified starch and maltodextrin and adjusting pH to 8.4; drying the alpha acid containing mixture to obtain a powder comprising about 30-33% by weight alpha acids, 2-3% isoalpha acids, and less than about 0.2% beta acids.

In yet another aspect, the invention provides an alpha-acid enriched hop composition containing at least about 30% alpha acids and less than about 0.5% or 0.2% beta acids. In another embodiment, the composition further contains an edible carrier.

The invention further provides hop compositions prepared a method of any previous aspect or a method otherwise delineated herein.

In various embodiments of a previous aspect, the invention further involves drying the hop composition. In other embodiments the method further involves mixing the hop composition with an edible carrier that is any one or more of starch, maltodextrin, cyclodextrin, methylcellulose, carbomethoxy cellulose, and xanthan gum. In still other embodiments, the pH value of the first aqueous solution is adjusted to 8.4. In still other embodiments, the method further involves drying the hop composition.

Any of the hop compositions mentioned above can be dried to form a powder. These compositions, either in liquid form or dry form, can be mixed with an edible carrier (e.g., starch, maltodextrin, cyclodextrin, methylcellulose, carbomethoxy cellulose, or xanthan gum) to form a mixture useful for making a food product. In one example, the mixture contains at least about 25-40% (e.g., 25-30%, 30-35%, or 35-40%) by weight hop alpha acids.

Also within the scope of this invention are hop compositions prepared by any of the methods described above and food products containing such hop compositions.

The details of one or more embodiments of the invention are set forth in the description below. Other features or advantages of the present invention will be apparent from the following detailed description of several embodiments, and also from the appending claims.

### Definitions

By “alpha acid” is meant an organic acid derived from a hop plant (Humulus lupulus) having structural homology to a humulone, adhumulone, cohumulone, or an analog or derivative thereof. Humulone, adhumulone, and cohumulone are the three most abundant alpha acid analogs. Other exemplary derivatives of an alpha acid include, but are not limited to isoalpha acids, rhoisoalpha acids, tetrahydroisoalpha acids, and hexahydroisoalpha acids.

By “alpha acid enriched hop composition” is meant a composition that comprises alpha acids but that has negligible levels of beta acids. For example, an alpha acid enriched hop composition contains less than about 0.5%, 0.3%, 0.2%, or 0.1%.

By “beta acid” is meant an organic acid derived from a hop plant (Humulus lupulus) having structural homology to a lupulone, adlupulone, colupulone or an analog or derivative thereof. Lupulone, adlupulone, and colupulone are the three most abundant beta acid analogs.

Other exemplary derivatives of a beta acid include, but are not limited to, hulupones, hexahydrobeta acids and hexahydro hulupones.

In this disclosure, “comprises,” “comprising,” “containing” and “having” and the like can have the meaning ascribed to them in U.S. patent law and can mean “ includes,” “including,” and the like; “consisting essentially of” or “consists essentially” likewise has the meaning ascribed in U.S. patent law and the term is open-ended, allowing for the presence of more than that which is recited so long as basic or novel characteristics of that which is recited is not changed by the presence of more than that which is recited, but excludes prior art embodiments.

By “hop derivative” is meant any molecule that naturally occurs in hops (Humulus lupulus) and chemical derivatives thereof. Hop derivatives (e.g., alpha acids, beta acids) may be purified from hops or may be chemically synthesized.

As used herein, “obtaining” as in “obtaining a compound” includes synthesizing, purchasing, or otherwise acquiring the compound.

By “reference” is meant a standard or control condition.

### DETAILED DESCRIPTION OF THE INVENTION

Described herein is a method for preparing a hop composition that is enriched for alpha acids (e.g., 70-95% by weight) and that contains a small amount of beta acids (e.g., <0.5% by weight).

In one approach, the starting material is an alpha acid-rich hop extract, which is either commercially available (e.g., Alphahop provided by John I Hass, Inc.) or is prepared by methods known in the art (e.g., CO₂ extraction; see U.S. Pat. No. 4,298,626). An alpha acid-rich hop extract typically contains about 40-85% (e.g., 50-85%) by weight alpha acids. It can be dissolved in water or a water-containing solvent to form a first aqueous solution. When adjusting the pH value of the first aqueous solution to 7-9, preferably 8.4, the beta acids and other non-alpha acid hop components become water insoluble and therefore form precipitates. The water insoluble materials can be removed via, e.g., filtration or centrifugation, to produce a second aqueous solution, a hop composition containing an increased amount of alpha acids and a reduced amount of beta acids relative to the starting material.

If desired, beta acids and other hydrophobic hop components contained in the second aqueous solution can be further removed by one of the methods described below.

In one example, the second aqueous solution is mixed with a water-soluble sugar or sugar alcohol that reduces the water solubility of the beta acids and other hydrophobic hop components. The precipitates thus formed are then removed to form a hop composition that is enriched for alpha acids and that contains a reduced amount of beta acids. In various embodiments, the alpha acid enriched composition comprise at least about 70%, 75%, 80%, 85%, 90%, 95%, 96%, 97%, 98%, 99%, or even 100% hop alpha acids. The sugar used in this method can be a monosaccharide (e.g., glucose), an oligosaccharide (e.g., fructo-oligosaccharides or galacto-oligosaccharides), or a polysaccharide (e.g., maltodextrin or starch). The term “starch” used herein refers to both naturally occurring and modified starches. The sugar alcohol used in this method, also known as polyol, polyhydric alcohol, or polyalcohol, is a hydrogenated form of carbohydrate, whose carbonyl group has been reduced to a primary or secondary hydroxyl group. The general formula of a sugar alcohol is H(HCHO)ₘ₊₁H. Examples of sugar alcohols include, but are not limited to, glycol, glycerol, erythritol, arabitol, xylitol, ribitol, mannitol, sorbitol, isomalt, maltitol, and lactitol.

In another example, the second aqueous solution is in contact with a water insoluble polymeric adsorbent to allow binding of beta acids and other hydrophobic hop components to the polymeric adsorbent. The polymeric adsorbent can be soaked in the second aqueous solution for a sufficient period of time and then removed (e.g., by filtration) together with the bound beta acids and other hydrophobic hop components. Alternatively, the polymeric adsorbent is packed in a column for the aqueous solution to pass through. In this process, hydrophobic hop components (e.g., beta acids) are bound to the column and thereby removed. In various approaches, ion exchange resins and hydrophobic/hydrophilic affinity resins are used as the polymeric adsorbent. Examples include, but are not limited to, Amberlite FPX 66, XAD7HP, Zeolite, polyvinylpolypyrrolidone (PVPP), and charcoal (preferably acid-treated charcoal).

If desired, the hop compositions described herein are dried to produce hop powders. In one embodiment, the hop compositions, either in liquid or dry form, are mixed with an edible carrier to form a mixture. The edible carrier is any one or a combination of starch (naturally occurring or modified), maltodextrins, cyclodextrin (naturally occurring or modified), methyl cellulose, carbonmethoxy cellulose, xanthan gum, clusterdextrin, corn syrup solids, glucose, arabic gum, calaginan, inuline, rosin, partially hydrogenated soybean oil, cellulose, hydroxymethy cellulose, hydroxyethyl cellulose, hydroxypropyl cellulose, hypomellose, or any other edible carrier known in the art. In another embodiment, the carrier is in solid form or liquid form. In one embodiment, the carrier is in an aqueous solution at a concentration of about 20%, 30%, 50%, 75% or 90% (w/v). In another embodiment, this aqueous solution is adjusted to pH 7-9 (e.g., 7, 8, 8.4, 9) before mixing with the hop composition.

The hop compositions described herein, preferably mixed with an edible carrier, may be used as a food preservative for making food products.

Hop Derivatives

A hop derivative is a compound that occurs naturally in a hop plant (Humulus lupulus) or is chemically derived (either through natural biosynthetic processes (e.g., living organism is metabolism (e.g., mammal, plant, bacteria)) or by synthetic processes using human intervention (e.g., chemical synthesis). Compositions of the invention include one or more compounds derived from hops. Of particular interest are the hop acids. Hops contain two major organic acid classes, alpha acids and beta acids. Hop acids are the bitter acid components of hops that are used in beer making. There are three major analogs for alpha acids, humulone, cohumulone, and adhumulone, and three major analogs for beta acids, lupulone, colupulone, and adlupulone. The percentages of the analogs present in the alpha acids and beta acids are variety-dependent. Thus, hop derivatives and hop products typically contain one or a mixture of these analogs. The percentage of analog present is dependent on the hop variety used to produce the derivative or product. Alpha acids and beta acids can be prepared by purification from natural hops and also by chemical synthesis according to traditional methods. Exemplary hop derivatives include beta acids, hexahydrobeta acids, rhoisoalpha acids, isoalpha acids, tetrahydroisoalpha acids, hexahydroisoalpha acids, magnesium salts of rhoisoalpha acids and magnesium salts of beta acids. Compositions comprising hop derivatives are also available commercially. John I. Haas, Inc. products containing hop derivatives include BetaStab® 10A, also referred to hereafter as Betacide, Redihop□, Isohop□, Tetrahop Gold□, Hexahop Gold□, magnesium salts of rhoisoalpha acids, and magnesium salts of beta acids. The active ingredients in these products are beta acids, rhoisoalpha acids (RIAA), isoalpha acids (IAA), tetrahydroisoalpha acids (THIAA), hexahydroisoalpha acids (HHIAA), magnesium salts of rhoisoalpha acids (MgRIAA) and magnesium salts of beta acids, respectively. These products and/or hop derivatives are typically diluted to a desired concentration for use in the methods of the invention.

Plant extracts are often used for the purification of compounds from plants (e.g., hops). An extract can be prepared by drying and subsequently cutting or grinding the dried material. The term “extract” refers to a concentrated preparation of the essential constituents of a plant, such as hops. Typically, an extract is prepared by drying and powderizing the plant. Optionally, the plant, the dried plant or the powderized plant may be boiled in solution. The extract may be used in liquid form, or it may be mixed with other liquid or solid herbal extracts. Alternatively, the extract may be obtained by further precipitating solid extracts from the liquid form. The extraction process may then be performed with the help of an appropriate choice of solvent, typically ethanol/water mixture, methanol, butanol, iso-butanol, acetone, hexane, petroleum ether or other organic solvents by means of maceration, percolation, repercolation, counter-current extraction, turbo-extraction, or by carbon-dioxide supercritical (temperature/pressure) extraction. The extract may then be further evaporated and thus concentrated to yield by means of air drying, spray drying, vacuum oven drying, fluid-bed drying or freeze-drying, the extract product.

Numerous methods are available for the chemical synthesis of compounds of the invention. Such compounds can be synthesized from readily available starting materials using standard synthetic techniques and methodologies known to those of ordinary skill in the art. Synthetic chemistry transformations and protecting group methodologies (protection and deprotection) useful in synthesizing the compounds identified by the methods described herein are known in the art and include, for example, those such as described in R. Larock, Comprehensive Organic Transformations, VCH Publishers (1989); T. W. Greene and P. G. M. Wuts, Protective Groups in Organic Synthesis, 2nd ed., John Wiley and Sons (1991); L. Fieser and M. Fieser, Fieser and Fieser's Reagents for Organic Synthesis, John Wiley and Sons (1994); L. Paquette, ed., Encyclopedia of Reagents for Organic Synthesis, John Wiley and Sons (1995); and M. Verzele and D. De Keukeleire, Chemistry and Analysis of Hop and Beer Bitter Acids, Elsevier: Amsterdam (1991). Chemically synthesized alpha and beta acids can be separated from a reaction mixture and further purified by a method such as column chromatography, high pressure liquid chromatography, or recrystallization. As can be appreciated by the skilled artisan, further methods of synthesizing the compounds herein will be evident to those of ordinary skill in the art. Additionally, the various synthetic steps may be performed in an alternate sequence or order to give the desired compounds.

The compounds of this invention may contain one or more asymmetric centers and thus occur as racemates and racemic mixtures, single enantiomers, individual diastereomers and diastereomeric mixtures. All such isomeric forms of these compounds are expressly included in the present invention. The compounds of this invention may also be represented in multiple tautomeric forms, in such instances, the invention expressly includes all tautomeric forms of the compounds described herein. All such isomeric forms of such compounds are expressly included in the present invention. All crystal forms of the compounds described herein are expressly included in the present invention. As used herein, the compounds of this invention, including the compounds of formulae described herein, are defined to include derivatives. Derivatives include compounds of the invention that are modified by appending appropriate functionalities to enhance desired properties.

Acceptable salts of the compounds of this invention include those derived from acceptable inorganic and organic acids and bases. Examples of suitable acid salts include acetate, adipate, alginate, aspartate, benzoate, benzenesulfonate, bisulfate, butyrate, citrate, camphorate, camphorsulfonate, digluconate, dodecylsulfate, ethanesulfonate, formate, fumarate, glucoheptanoate, glycolate, hemisulfate, heptanoate, hexanoate, hydrochloride, hydrobromide, hydroiodide, 2-hydroxyethanesulfonate, lactate, maleate, malonate, methanesulfonate, 2-naphthalenesulfonate, nicotinate, nitrate, palmoate, pectinate, persulfate, 3-phenylpropionate, phosphate, picrate, pivalate, propionate, salicylate, succinate, sulfate, tartrate, thiocyanate, tosylate and undecanoate. Other acids, such as oxalic acid, may be employed in the preparation of salts useful as intermediates in obtaining the compounds of the invention and their acceptable acid addition salts. Salts derived from appropriate bases include alkali metal (e.g., sodium), alkaline earth metal (e.g., magnesium), ammonium and N-(alkyl)4+ salts. This invention also envisions the quaternization of any basic nitrogen-containing groups of the compounds disclosed herein. Water or oil-soluble or dispersible products may be obtained by such quaternization.

### Kits

The invention provides kits comprising a composition enriched for alpha acids and having a reduced amount of beta acids. In one embodiment, the kit includes a composition containing an effective amount of alpha acids suitable for use as a food preservative. In some embodiments, the kit comprises a container which contains the alpha acids; such containers can be boxes, ampoules, bottles, vials, tubes, bags, pouches, blister-packs, or other suitable container forms known in the art. Such containers can be made of plastic, glass, laminated paper, metal foil, or other materials suitable for holding an alpha acid enriched food preservative composition.

If desired the alpha acid enriched composition of the invention is provided together with instructions for using the composition as a food preservative. In other embodiments, the instructions include at least one of the following: description of the composition; precautions; warnings; description of research studies; and/or references. The instructions may be printed directly on the container (when present), or as a label applied to the container, or as a separate sheet, pamphlet, card, or folder supplied in or with the container.

The following examples are put forth so as to provide those of ordinary skill in the art with a complete disclosure and description of how to make and use the assay, screening, and therapeutic methods of the invention, and are not intended to limit the scope of what the inventors regard as their invention.

### EXAMPLE

### Preparation of Alpha Acid-Enriched Hop Powder

800 g Alpha hop, an alpha-acid rich hop CO₂ extract containing 80% by weight alpha acids, 3% beta acids, and 2% isoalpha acids, was preheated to 60-65° C. and then mixed with 3.2 L water, which was also preheated to 60-65° C. After the Alphahop was well dissolved in the water to produce a solution, NaOH (2 mols) was added to the solution to adjust its pH to a value of 7.4. The solution was mixed for 30 minutes and NaOH was added, if necessary, to maintain the pH value at 7.4. After keeping the solution at room temperature overnight, its pH was again adjusted with NaOH to a value of 8.0 to 8.4. The solution was then filtrated to remove insoluble materials, such as wax and oil. The filtrate was loaded onto a column packed with Amberlite FPX66 (food grade; column volume 300 ml) and a brown solution that passed through the column was collected. This solution was mixed with water to form a mixture (about 3.6 L) containing 16% alpha acids.

320 g modified starch (CAPSUL, National Starch) and 640 g maltodextrin (CLINTOSE CR-10, ADM) were dissolved in 2.6 L de-ionized water to produce a solution (3.2 L) containing 30% by weight of the modified starch and maltodextrin in combination, The solution was then mixed with NaOH to reach a pH value of 8.4.

The alpha-acid containing mixture described above was mixed with the starch/maltodextrin-containing solution to form an aqueous solution (6.0 L), which was then spray dried to yield a powder containing 30-33% by weight alpha acids, 2-3% isoalpha acids, and less than 0.2% beta acids.

### OTHER EMBODIMENTS

From the foregoing description, it will be apparent that variations and modifications may be made to the invention described herein to adopt it to various usages and conditions. Such embodiments are also within the scope of the following claims.

The recitation of a listing of elements in any definition of a variable herein includes definitions of that variable as any single element or combination (or subcombination) of listed elements. The recitation of an embodiment herein includes that embodiment as any single embodiment or in combination with any other embodiments or portions thereof.

All patents and publications mentioned in this specification are herein incorporated by reference to the same extent as if each independent patent and publication was specifically and individually indicated to be incorporated by reference.

What is claimed is:

1. A method of preparing an alpha acid-enriched hop composition, comprising:
dissolving in water a hop extract comprising alpha acids and beta acids to obtain a first aqueous solution, wherein the content of the alpha acids in the hop extract is about 50-85% by weight,
adjusting the pH value of the first aqueous solution to 7-9 to precipitate the beta acids; and
removing the precipitated beta acids to obtain an alpha acid-enriched hop composition, which, when in dry form, contains at least about 70-95% by weight alpha acids and about 0.05-0.5% by weight beta acids.

2. The method of claim 1, further comprising drying the hop composition.

3. The method of claim 1, further comprising mixing the hop composition with an edible carrier.

4. The method of claim 3, wherein the edible carrier is selected from the group consisting of starch, maltodextrin, cyclodextrin, methylcellulose, carbomethoxy cellulose, and xanthan gum.

5. The method of claim 1, wherein the pH value of the first aqueous solution is adjusted to 8.4.

6. A method of preparing an alpha-acid enriched hop composition, comprising:
dissolving in water a hop extract comprising alpha and beta acids to obtain a first aqueous solution, wherein the content of the alpha acids in the hop extract is 50-85% by weight;
adjusting the pH value of the first aqueous solution to 7-9 to allow precipitation of the beta acids;
removing the precipitated beta acids to form a second aqueous solution;
mixing the second aqueous solution with a sugar or a sugar alcohol to allow formation of precipitates,
removing the precipitates to form an alpha-acid enriched hop composition, which, when in dry form, contains at least about 25-50% by weight alpha acids and about 0.02-0.2% by weight beta acids.

7. The method of claim 6, further comprising drying the hop composition.

8. The method of claim 6, wherein second aqueous solution is mixed with a monosaccharide or an oligosaccharide.

9. The method of claim 6, wherein the second aqueous solution is mixed with a polysaccharide.

10. The method of claim 9, wherein the polysaccharide is maltodextrin or starch.

11. The method of claim 6, wherein the second aqueous solution is mixed with a sugar alcohol selected from the group consisting of mannitol, sorbitol, and xylitol.

12. The method of claim 6, wherein the pH value of the first aqueous solution is adjusted to 8.4.

13. A method of preparing an alpha-acid enriched hop composition, comprising:
dissolving in water a hop extract comprising alpha and beta acids to obtain a first aqueous solution, wherein the content of the alpha acids in the hop extract is 50-85% by weight,
adjusting the pH value of the first aqueous solution to about 7-9 to allow precipitation of the beta acids,
removing the precipitated beta acids to form a second aqueous solution,
mixing the second aqueous solution with a water insoluble polymeric adsorbent,
removing the water insoluble polymeric adsorbent to form an alpha acid-enriched hop composition, which, when in dry form, contains at least about 70-95% by weight alpha acids and about 0.05-0.5% by weight beta acids.

14. The method of claim 13, further comprising drying the hop composition.

15. The method of claim 13, further comprising mixing the hop composition with an edible carrier.

16. The method of claim 15, wherein the edible carrier is selected from the group consisting of starch, maltodextrin, cyclodextrin, methylcellulose, carbonmethoxy cellulose, and xanthan gum.

17. The method of claim 13, wherein the polymeric adsorbent is selected from the group consisting of Amberlite FPX 66, XAD7HP, Zeolite, polyvinylpolypyrrolidone (PVPP), and charcoal.

18. The method of claim 13, wherein the pH value of the first aqueous solution is adjusted to 8.4.

19. A hop composition prepared by the method of claim 2.

20. A hop composition prepared by the method of claim 7.

21. A hop composition prepared by the method of claim 14.

22. A method of preparing an alpha-acid enriched hop composition, comprising:
Preheating a hop composition comprising about 80% by weight alpha acids and about 3% beta acids to 60-65° C. with water to form a solution;
adjusting the pH of the solution to 8.0 to 8.4 and removing insoluble materials to obtain a first solution;
contacting the first solution with a polymeric adsorbent and obtaining a second aqueous solution comprising about 16% alpha acids;
Contacting the second aqueous solution with a modified starch to produce an alpha acid containing mixture comprising about 30% by weight of the modified starch and maltodextrin and adjusting pH to 8.4;
Drying the alpha acid containing mixture to obtain a powder comprising about 30-33% by weight alpha acids, 2-3% isoalpha acids, and less than about 0.2% beta acids.

23. An alpha-acid enriched hop composition comprising at least about 30% alpha acids and less than about 0.5% beta acids.

24. The alpha acid enriched hop composition of claim 23, further comprising an edible carrier.
